(19) United States
(12) Patent Application Publication
(10) Pub. No.: US 2010/0129775 A1
(43) Pub. Date: May 27, 2010

(54) Method of bonding pigmented polymeric coatings onto the surace of metallic orthodontic tools and appliances

(76) Inventor: Robert Petcavich, Kirkland, WA (US)

Correspondence Address: CHERNOFF, VILHAUER, MCCLUNG & STENZEL, LLP, 601 SW Second Avenue, Suite 1600, PORTLAND, OR, 97204-3157, US

(21) Appl. No.: 12/313,582

(22) Filed: Nov. 21, 2008

(51) Int. Cl. A61C 7/12

(52) U.S. Cl. 433/215; 433/8

(57) ABSTRACT

This invention discloses a method of bonding FDA approved pigmented polymeric film forming coatings onto the surface of metallic orthodontic tools and appliances. In the preferred embodiment, stainless steel orthodontic brackets are coated with a functionalized coating that bonds to the metal surface and reacts with the molecules present at the surface as well as functional groups present in the coating formulation. In the present invention, the pigmented coating can be any polymeric material with epoxy, phenolic, carboxylic acid, urethane, or acrylic functionality able to form a continuous film upon curing.

### CROSS-REFERENCE To RELATED APPLICATIONS

This application claims priority to U.S. provisional patent application Ser. No. 60/004,002 filed on Nov. 23, 2007, the complete disclosure of which being incorporated herein by reference.

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO SEQUENCE LISTING, A TABLE, OR A COMPUTER PROGRAM LISTING COMPACT DISC APPENDIX

Not applicable.

### BACKGROUND OF THE INVENTION

1. Field of the Invention

The invention relates to a colored orthodontic appliance and to a method for coating the exterior surface of orthodontic appliances, which allows for imparting color to the exterior surface of the orthodontic metal brackets which are subsequently bonded onto the teeth. The invention also concerns a method for applying pigmented or contrast-inducing coatings for aesthetic and fashion reasons to exterior facing surfaces of orthodontic brackets, appliances and tools. As used herein, the term “orthodontic appliance” may refer to a bracket, brace or orthodontic tool.

2. Description of Related Art Including Information Disclosed Under 37 CFR 1.97 and 1.98

For cosmetic reasons, and to minimize patient discomfort, orthodontic appliances are generally made as small as is practically possible. Orthodontic appliances, which had previously been constructed almost exclusively from metal alloys, are now being fabricated from natural tooth-colored material such as porcelain or sapphire materials or plastics. These natural-colored appliances, because of their innocuous appearance, are becoming increasingly popular with patients. Orthodontists, however, find it more difficult to discern the features of these small natural tooth-colored appliances since they provide very little visual contrast between the natural tooth-colored appliances and the patient's white teeth.

To overcome the problem of visibility of the small, non-contrasting orthodontic components, a variety of techniques have been developed to increase visibility during initial installation of the orthodontic appliances. Brackets have been marked on certain surfaces with colored dots and other indicators to indicate the direction of torque or to help the dentist differentiate right-sided, left-sided, upper and lower brackets. Removable color-coded long axis indicators have been provided by Unitek Corporation in its “Transcend” brand brackets for giving a positive placement reference for the axis, with each tooth having its own color code for easy selection and identification. Color-coded identification marks have also been cast into brackets. Ormco Corporation has made color-coded vertical and horizontal placement caps for its “GEM” brand brackets and also has made metal brackets with color-coded placement/identification caps for specific teeth and with different vertical displacements.

U.S. Pat. No. 4,952,141 discloses a removable marker in the slot of an orthodontic bracket. The marker, which facilitates visual alignment of the brackets during their initial installation, must be either brushed or scraped out of the slot after the bracket has been cemented to a tooth.

These conventional marking or coloring techniques are generally employed only during the initial installation of orthodontic appliances and are of no permanent aesthetic or fashionable appeal to the patient.

### BRIEF DESCRIPTION OF THE SEVERAL VIEWS OF THE DRAWINGS

FIG. 1 is a perspective view of a cross section of a metallic orthodontic part coated with a self-assembled monolayer and pigmented polymeric coating.

### DETAILED DESCRIPTION OF PREFERRED EMBODIMENT

A dental appliance having a desired color is achieved by the direct application of a pigmented polymeric coating onto the orthodontic brackets. Any of a variety FDA approved polymeric coatings may be used, and those having GRAS status are preferred, since they have already been proven to be non-toxic and safe for use in a patient's mouth, and do not require any further regulatory approval. Additionally, the pigmented polymeric coating should provide high visual color contrast to the orthodontic appliances. Another important characteristic of the polymeric coating is that it be chemically and abrasion resistant to body fluids and teeth cleaning aids such as toothpaste.

The pigmented polymeric coating is applied directly to the orthodontic appliance prior to installation on the tooth, or in the case of orthodontic tools during the manufacturing of the tool prior to sale. In both of these examples, the method used to apply the coating involves a two-step process. During the first step of the method, a primer is applied which bonds to the molecules on the surface of the metal on the orthodontic appliance. In a second step, a pigmented polymeric coating is applied, which can be an epoxy, urethane, phenolic, carboxylic acid or acrylic that has been formulated for chemical, abrasion, and temperature resistance. The coating may be formulated such that in the dry cured state the color matches the color of natural teeth, or may provide a chosen color in the range of 400 to 750 nanometers.

The method of the invention, therefore, provides a safe, simple procedure having no harmful side effects or disadvantages, which visually creates an orthodontic appliance or tool with a variety of colors, thereby allowing aesthetic and fashion appeal to end users.

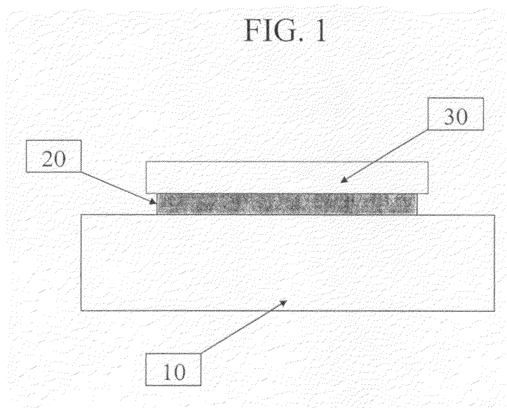

Referring to FIG. 1, which shows a partial cross sectional view of a typical appliance, the method set forth below employs a highly reactive FDA approved molecular coating 20, as an interface layer between a metal orthodontic appliance 10 and a pigmented polymeric coating 30.

The first step in the process is to wash the appliance in deionized water to remove impurities and debris.

The next step in the process is the application of a highly reactive layer 20 that has at least two chemical functionalities built into the molecule. First, the molecules of the layer 20 bond with the metal surface of the appliance, and second, as a will be explained below, the molecules also form covalent bonds with a pigmented polymer layer. The reactive layer 20 may be applied by dip, brush, or spray coating onto the metal surface to be subsequently coated with pigmented polymeric coating. The coating layer 20 is a self-assembled monolayer (SAM) whose molecules bind to the oxidized metal surface of the appliance or tools. Examples of SAM layer molecules are disclosed, for example, in U.S. Pat. No. 6,146,767, and SAM coating materials are available from Aculon, Inc. in San Diego, Calif. The coating layer 20 may be applied via a solvent carrier and allowed to dry. The coating layer 20 should then react with the majority of the molecules present on the surface of the metallic part to be coated. Most of the metals 10 used in orthodontic appliances and tools are stainless steel or titanium, to which a SAM layer will bond.

After the initial interface bonding onto the metal surface by reactive coating layer 20, a pigmented polymeric coating 30 is applied over the reactive layer 20. The reactive layer 20 has a functional group in its molecular structure that will bond to the polymeric coating thus providing a method whereby the polymer coating 30 is covalently attached to the surface of the metal appliance 10 through the interface formed by the reactive layer 20. This covalent attachment provides a pigmented coating that is highly resistant to chemicals, water, and abrasion, which heretofore has been impossible to attain in particular on stainless steel and titanium surfaces. The pigmented polymeric coating 30 can be applied by dip, brush, or spray coating and can range in thickness from 50 nanometers to 0.025 inches with 12 to 100 microns being preferred. The pigment used in the polymeric coating can be organic or inorganic in nature and can provide color from 400 (blue) to 750 (red) nanometers in wavelength or mimic the natural coloring of teeth. In addition the pigment can provide abrasion resistance to the coating as well. Any polymer coating 30 can be used that forms a mechanically strong continuous film in the dry or cured state, such as polyesters, acrylics, urethanes, epoxies, phenolic, carboxylic acids, ethers, polyols, cyanoacrylates or any combination of the aforementioned polymers. In the preferred embodiment epoxies, phenolic and acrylic polymers are preferred.

The polymeric pigmented coating 30 for use in accordance with the invention should be non-toxic and non-hazardous, and should preferably be FDA-approved for contact with body fluids. Three products that are commercially available that can be used are made by the Loctite company called medical grade epoxy M-21HP white, Masterbond corporation epoxy polymer system EP45HTMED, and an epoxy made by Valspar Corporation. FDA-approved pigmented coatings are preferred because they do not require any additional regulatory approval and are known to be safe for oral use.

An example of an acceptable pigmented coating 30 is an epoxy containing a selected pigment, which is sprayed onto appliances or tools having the SAM primer coating layer 20. This epoxy is a pigmented polymer which can be obtained form Valspar, Inc. of Rochester, Pa., and is known as WB epoxy coating 30Q10AA.

After spraying, the appliances or tools are baked in an oven at temperatures that may range from 400° F. to 430° F., but which is preferably about 415° F., for a period of five to ten minutes.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I claim:

1. A process for imparting a colored coating to an orthodontic appliance comprising the steps of:
a) applying a primer coating to the appliance, said primer coating comprising a SAM layer;
b) applying a pigmented polymer coating on top of the primer coat; and
c) curing the pigmented coating by heating the appliance in an oven.

2. An orthodontic appliance having a colored coating providing at least one color in the range of 400 to 750 nanometers.

3. The orthodontic appliance of claim 2 wherein said coating is a pigmented polymer layer.

4. The orthodontic appliance of claim 3 further containing a primer layer beneath the pigmented epoxy polymer layer, said primer layer comprising a SAM layer.

5. The process of claim 1 wherein said curing step (d) is performed by heating the appliances in an oven to a temperature of between 400° F. to 430° F. for about five to ten minutes.

6. The process of claim 5 wherein said step (c) is performed by spraying pigmented polymer material onto the SAM layer to form a pigmented polymer layer.

7. The orthodontic appliance of claim 2 further including a primer layer comprising a SAM layer underneath the colored coating.

8. An orthodontic appliance having a colored coating providing the approximate color of natural teeth wherein the appliance is made of metal

9. The orthodontic appliance of claim 8 wherein said coating is a pigmented polymer layer.

10. The orthodontic appliance of claim 9 further including an interface layer between the appliance and the pigmented polymer layer, said interface layer being made of a self-assembled monolayer.

11. The process of claim 1 further including the step of cleaning the appliance with deionized water prior to performing step (a).
